(19) United States
(12) Patent Application Publication
(10) Pub. No.: US 2026/0041123 A1
(43) Pub. Date: Feb. 12, 2026

(54) AQUARIUM FEED WITH SLOW-RELEASE FUNCTION, AND PREPARATION METHOD AND USES THEREOF

(71) Applicants: San Francisco Bay Brand, Inc., Newark, CA (US); Mega Jumbo Food Industry Limited, Huizhou (CN); Solis High-Tech Ind.(ShenZhen)Ltd., Shenzhen (CN)

(72) Inventors: Christopher Tully TURK, Newark, CA (US); Tin Han CHIEN, Taiwan (CN)

(73) Assignees: San Francisco Bay Brand, Inc., Newark, CA (US); Mega Jumbo Food Industry Limited, Huizhou (CN); Solis High-Tech Ind.(ShenZhen)Ltd., Shenzhen (CN)

(21) Appl. No.: 18/919,670

(22) Filed: Oct. 18, 2024

(30) Foreign Application Priority Data
Aug. 8, 2024 (CN) 202411085870.3

(51) Int. Cl. A23K 50/80; A01K 63/00; A23K 40/00

(52) U.S. Cl. CPC A23K 50/80; A01K 61/80; A23K 10/22; A23K 40/00

(57) ABSTRACT

The present disclosure provides an aquarium feed with slow-release function, and preparation method and uses thereof. Raw materials of the aquarium feed comprise granulated feeds with different particle sizes and slow-release binding agent; the granulated feeds with different particle sizes are bonded by the slow-release binding agent; the slow-release binding agent contains attractant and slow-release adhesive; and the slow-release adhesive is gel-like in water. The aquarium feed in the present disclosure can be slowly released into tiny particles with uneven size in water, allowing aquarium creatures with different body sizes or living in different water layers (comprising surface, middle and bottom layers) to find suitable food for themselves, thus improving the feed utilization rate and aquarium creatures' weight growth rate, and reducing difference of the body length.

### CROSS-REFERENCE TO RELATED APPLICATIONS

The present application claims the benefit of and priority to Chinese Patent Application No. 202411085870.3, filed on Aug. 8, 2024, the entire disclosures of which are incorporated herein by reference.

### TECHNICAL FIELD

The present disclosure relates to the field of feed, in particular to an aquarium feed with a slow-release function, and a preparation method and uses thereof.

### BACKGROUND

At present, commonly aquarium feeds used in the market are mainly granular, pellets, blocks, flakes, or strip-shaped. Although these traditional feeds can provide basic nutrition, there are some problems that cannot be ignored in practical application.

First of all, the traditional feeds are easy to melt in water. Once placed in the water, the nutrients in most feeds dissolve too quickly, or the feed remains too hard and is easily carried by the current to the corners of the aquarium, making it difficult for aquatic creatures to eat. The parts that are not eaten by aquarium creatures in time will sink to the bottom of the water or dissolve in the water, resulting in feed waste. This not only increases the cost, but also causes water pollution due to the accumulation of feed residues, which affects the growth and health of aquarium creatures.

Secondly, the traditional feeds are difficult to meet the constant nutritional needs of the aquarium creatures. The aquarium creatures is usually required to have constant feeding method to keep the healthy state. If they are not fed multiple times a day, it cannot provide long-term stable nutrition supply for aquarium creatures.

In addition, shapes and textures of the traditional feeds are insufficient to feed every kind of aquarium creatures which has different feeding habitats. Some aquarium creatures prefer soft texture, some prefer hard texture, and resulting need of feeding different types of feed each time to meet the different feeding habits of these aquarium creatures.

### SUMMARY

In order to solve the above-mentioned technical problem in the prior art, one aim of the present disclosure is to provide an aquarium feed.

Second aim of the present disclosure is to provide a preparation method of the aquarium feed described above.

Third aim of the present disclosure is to provide use of the aquarium feed described above in feed.

Fourth aim of the present disclosure is to provide a use method of the aquarium feed described above.

In order to achieve the above aims, the technical solutions adopted by the present disclosure are as follows.

First aspect of the present disclosure is to provide an aquarium feed. Raw materials of the aquarium feed comprise granulated feeds with different particle sizes and a slow-release binding agent; the granulated feeds with different particle sizes are bonded by the slow-release binding agent; the slow-release binding agent contains an attractant and a slow-release adhesive; and the slow-release adhesive is gel-like in water.

The aquarium feed according to the present disclosure uses the slow-release adhesive to bond the granulated feeds with different particle sizes together, forming sheets or blocks. The slow-release binding agent in the aquarium feed can make the aquarium feed stick to a fixed object, such as an aquarium feeding container or a movable hanging object. During the use of the aquarium feed, the slow-release adhesive absorbs water and expands to be soft gel-like, and the hard granulated feeds with different particle sizes are coated in the gel-like slow-release adhesive. Through the bite of fish, the granulated feeds are partially released, and the released granulated feeds attract more aquarium creatures to eat. Therefore, on one hand, the aquarium feed according to the present disclosure has a slow-release function, can slowly release feed in water, and effectively reduces water pollution and feed waste. On the other hand, the slow-release binding agent contains the attractant, which has strong feeding attraction activities, can improve food intake of the aquarium creatures and maintain good interest in feeding. In addition, the aquarium feed according to the present disclosure adopts the granulated feeds with different particle sizes, which can meet nutritional needs of aquarium creatures with different body sizes and reduce difference of body length between the aquarium creatures.

Preferably, a mass ratio of the attractant to the slow-release adhesive is 1:(0.5-10); further preferably, the mass ratio of the attractant to the slow-release adhesive is 1:(1-4).

Preferably, the aquarium feed comprises the following raw materials in percentage by mass: 15-35% of granulated feed A, 64-80% of granulated feed B and 1-9% of slow-release binding agent; and a particle size of the granulated feed A is smaller than that of the granulated feed B.

Preferably, 0.1 mm≤the particle size of the granulated feed A≤0.3 mm; and 0.3 mm<the particle size of the granulated feed B≤1 mm.

Preferably, the slow-release adhesive is selected from at least one of the group consisting of sodium alginate, alpha-starch, pectin, hydroxypropyl methylcellulose, sodium carboxymethyl cellulose, polyethylene glycol 400 and sodium polyacrylate; further preferably, the slow-release adhesive is selected from at least two of the group consisting of sodium alginate, alpha-starch, pectin, hydroxypropyl methylcellulose, sodium carboxymethyl cellulose, polyethylene glycol 400 and sodium polyacrylate.

Preferably, the attractant is selected from at least one of the group consisting of animal based attractant, plant based attractant and synthetic attractant; further preferably, the attractant contains animal based attractant and plant based attractant.

Preferably, the animal based attractant is selected from at least one of the group consisting of aquatic animal protein powder and insect protein powder; further preferably, the animal based attractant is selected from aquatic animal protein powder and insect protein powder.

Preferably, the animal based attractant is selected from at least one of the group consisting of fish protein powder, shrimp protein powder and Daphnia protein powder.

Preferably, the insect powder comprises at least one of Chironomid Larva protein powder, barley worm protein powder and yellow mealworm protein powder.

Preferably, the plant based attractant is selected from at least one of the group consisting of corn flour, wheat flour, mugwort leaf powder, brown sugar, maltose and natural flavor for food; further preferably, the plant based attractant is selected from corn flour, wheat flour, mugwort leaf powder, brown sugar, maltose and natural flavor for food (see Hygienic Standards for Uses of Food Additives (GB 2760) published by China).

Preferably, the synthetic attractant is selected from at least one of the group consisting of betaine, allicin, sodium glutamate and synthetic flavor for food (see Hygienic Standards for Uses of Food Additives (GB 2760) published by China).

Preferably, the aquarium feed is a paster feed. The paster feed refers to a feed that is in the shape of a sheet and has a certain degree of adhesion, which can be pasted on an inner wall of a feeding container or other object.

Preferably, the aquarium is selected from at least one of the group consisting of fish, shrimp, tortoise, soft-shelled turtle and Monopterus Albus.

Preferably, the granulated feed A comprises the following raw materials in percentage by mass: 10-55% of fish protein powder, 0-45% of shrimp, 0-30% of wheat flour, 0-20% of corn flour, 0-20% of yellow mealworm protein powder, 0-9% of Daphnia, 2-35% of soybean powder, 2-15% of beer yeast powder, 1.5-2.5% of garlic powder, 0.4-15% of pigment, 0.5-5% of lecithin, 0.5-1% of vitamin complex and 0.5-1% of trace element complex.

Preferably, the granulated feed B comprises the following raw materials in percentage by mass: 10-55% of fish protein powder, 0-45% of shrimp, 0-30% of wheat flour, 0-20% of corn flour, 0-20% of yellow mealworm protein powder, 0-9% of Daphnia, 2-35% of soybean powder, 2-15% of beer yeast powder, 1.5-2.5% of garlic powder, 0.4-15% of pigment, 0.5-5% of lecithin, 0.5-1% of vitamin complex and 0.5-1% of trace element complex.

Preferably, the shrimp is selected from at least one of the group consisting of krill, Acetes Chinensis, brine shrimp and freshwater shrimp.

Preferably, the pigment is selected from at least one of the group consisting of spirulina powder and astaxanthin.

Preferably, the vitamin complex is selected from at least one of the group consisting of vitamin A, D-biotin, D-calcium pantothenate, choline chloride, vitamin D3, folic acid, α-tocopherol, vitamin K3, vitamin B1, vitamin B2, vitamin B6, vitamin B12, niacin and inositol.

Preferably, the trace element complex comprises at least one of glycine-iron complex, amino acid-zinc complex, methionine-manganese complex, glycine-copper complex, calcium iodate, cobalt chloride, sodium selenite, magnesium sulfate and potassium chloride.

Second aspect of the present disclosure is to provide a preparation method of the aquarium feed according to the first aspect of the present disclosure, comprising the following steps of:
mixing the granulated feed with different particle sizes and the slow-release binding agent, and tabletting the mixture to obtain the aquarium feed.

Preferably, a preparation method of the granulated feed A comprises steps of: mixing and pulverizing various raw materials of the granulated feed A, and then granulating.

Preferably, a preparation method of the granulated feed B comprises steps of: mixing and pulverizing various raw materials of the granulated feed B, and then granulating.

Third aspect of the present disclosure is to provide use of the aquarium feed according to the first aspect of the present disclosure in feed.

Fourth aspect of the present disclosure is to provide a use method of the aquarium feed according to the first aspect of the present disclosure, comprising the following step of:
pasting the aquarium feed on a fixed object or a movable object.

Preferably, the fixed object comprises an aquarium feeding container.

Preferably, the movable object comprises a movable hanging object.

Preferably, the use method comprises the following steps of: pasting the aquarium paster feed on an inner wall of the aquarium feeding container; and/or, pasting the aquarium paster feed on the movable hanging object.

The present disclosure has the following beneficial effects: the aquarium feed according to the present disclosure can slowly release small and unevenly sized particles in water, so that aquarium creatures with different body sizes or living in different water layers (comprising surface layer, middle layer and bottom layer) can find suitable food for themselves, thus improving the feed utilization rate and the aquarium creatures' weight growth rate, and reducing difference of aquarium creatures body length. In addition, compared with the commercially available feeds, the aquarium feed according to the present disclosure can reduce ammonia nitrogen and nitrite contents in water and reduce pollution to water quality.

The preparation method of the aquarium feed according to the present disclosure is to directly tablet the granulated feeds with different particle sizes after mixing with the slow-release binding agent, thus avoiding contact with moisture, reducing the risk of microbial contamination, helping to protect stability of moisture or heat sensitive raw materials, preventing degradation or deterioration, significantly reducing the production process, reducing production cost and improving production efficiency.

### BRIEF DESCRIPTION OF THE DRAWINGS

FIG. 1 is a flow chart of the preparation process of the examples of the present disclosure.

FIG. 2A-2D are schematic diagrams of the testing of the effects of aquarium paster feed according to example 1 and a commercially available feed on ammonia nitrogen and nitrite in water, wherein 1 in FIG. 2A refers to the aquarium feeding container and 2 refers to the aquarium paster feed.

FIG. 3A-3C are schematic diagrams of the use method of aquarium paster feed according to the examples of the present disclosure.

FIG. 4 is a schematic diagram of the use method of the aquarium paster feed according to the examples of the present disclosure.

FIG. 5 is a schematic diagram of the testing of the effects of the aquarium paster feed according to example 1 and the commercially available feed on dissolved oxygen in water.

FIG. 6 is a schematic diagram of the testing of daily intakes of the aquarium paster feed according to example 1 and the commercially available feed.

FIG. 7 is a schematic diagram of the testing of ingestion rates of the aquarium paster feed according to example 1 and the commercially available feed.

FIG. 8 is a schematic diagram of the testing of slow-release effects of the aquarium paster feed according to example 1 and an ordinary paster feed.

### DETAILED DESCRIPTION OF THE EMBODIMENTS

The specific embodiments of the present disclosure will be further described in detail with the attached drawings and examples, but the implementation and protection of the present disclosure are not limited to this. It should be pointed out that the following processes, if not specified in detail, can be realized or understood by those skilled in the art with reference to the prior art. If the manufacturer of the reagent or the instrument used is not indicated, the reagent or the instrument is regarded as a commercially available conventional product.

The information of the raw materials used in the examples of the present disclosure is as follows.

The vitamin complex comprises vitamin A, D-biotin, D-calcium pantothenate, choline chloride, vitamin D3, folic acid, α-tocopherol, vitamin K3, vitamin B1, vitamin B2, vitamin B6, vitamin B12, niacin and inositol, which are commercially available products.

The trace element complex comprises glycine-iron complex, amino acid-zinc complex, methionine-manganese complex, glycine-copper complex, calcium iodate, cobalt chloride, sodium selenite, magnesium sulfate and potassium chloride, which are commercially available products.

The present disclosure has no specific requirements on the types of the vitamin complex and the trace element complex, and any similar commercial products on the market can be adopted.

### Example 1

This example provided an aquarium paster feed with a slow-release function, which comprised the following ingredients in percentage by mass: 15% of granulated feed A, 80% of granulated feed B and 5% of slow-release binding agent. 0.1 mm≤the particle size of the granulated feed A≤0.3 mm; and 0.3 mm<the particle size of the granulated feed B≤1 mm, and the ingredients of the granulated feed A and the granulated feed B were the same.

Both the granulated feed A and the granulated feed B comprised the following ingredients in percentage by mass:
55% of fish protein powder, 10% of Antarctic krill protein powder, 5% of wheat flour, 6% of yellow mealworm protein powder, 4% of Daphnia, 7% of soybean powder, 5% of beer yeast powder, 2% of garlic powder, 1% of astaxanthin, 1% of spirulina powder, 2% of lecithin, 1% of vitamin complex and 1% of trace element complex.

The slow-release binding agent comprised the following ingredients in percentage by mass: 20% of attractant and 80% of slow-release adhesive.

The attractant comprised the following ingredients in percentage by mass: 35% of fish protein powder, 15% of Antarctic krill protein powder, 10% of Chironomid Larva protein powder, 10% of corn flour, 10% of mugwort leaf powder and 20% of betaine.

The slow-release adhesive comprised the following ingredients in percentage by mass: 70% of sodium alginate, 15% of pectin and 15% of α-starch.

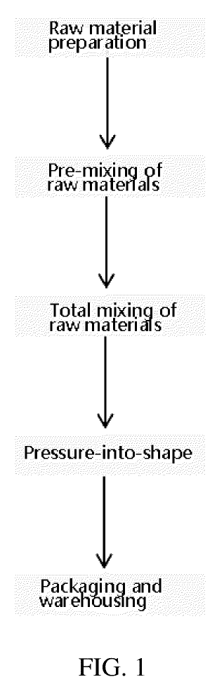

Referring to the schematic diagram of preparation process shown in FIG. 1, the aquarium paster feed with the slow-release function in this example was prepared by the following preparation method, which comprised the following steps of:
(1) Raw material preparation: amount of each raw material was calculated according to a weight of a paster required, raw materials of the granulated feed A and the granulated feed B were accurately weighed, pulverized and mixed, then expanded and granulated, and then dried at a temperature of above 70° C. for more than 15 minutes until moisture in the granulated feed A and the granulated feed B was below 10%, drying was stopped and the granulated feed A and the granulated feed B were obtained;
(2) Pre-mixing of raw materials: 15% by mass of the granulated feed A and 5% by mass of the slow-release binding agent were transferred into a mixer for uniform mixing;
(3) Total mixing of raw materials: 80% by mass of the granulated feed B was poured into the mixture of step (2), and stirred and mixed evenly again;
(4) Tablet molding: the mixed raw materials obtained in step (3) were transferred to a tabletting press for tabletting to obtain the aquarium paster feed with the slow-release function in this example; and
(5) Packaging and warehousing: the aquarium paster feed obtained in step (4) was packaged according to a specified packing specification to ensure the product to be matched with an outer box, correctness of a production date and a shelf life, and the product was placed into a finished product warehouse as required.

### Example 2

This example provided an aquarium paster feed with a slow-release function, which comprised the following ingredients in percentage by mass: 20% of granulated feed A, 76% of granulated feed B and 4% of slow-release binding agent. 0.1 mm≤the particle size of the granulated feed A≤0.3 mm; and 0.3 mm<the particle size of the granulated feed B≤1 mm, and the ingredients of the granulated feed A and the granulated feed B were the same.

Both the granulated feed A and the granulated feed B comprised the following ingredients in percentage by mass:
30% of fish protein powder, 15% of Acetes Chinensis protein powder, 12% of wheat flour, 8% of corn flour, 9% of yellow mealworm protein powder, 6% of Daphnia, 9% of soybean powder, 3% of beer yeast powder, 1.5% of garlic powder, 2.5% of astaxanthin, 3% of lecithin, 0.5% of vitamin complex and 0.5% of trace element complex.

The slow-release binding agent comprised the following ingredients in percentage by mass: 30% of attractant and 70% of slow-release adhesive.

The attractant comprised the following ingredients in percentage by mass: 30% of fish protein powder, 30% of Acetes Chinensis protein powder, 10% of yellow mealworm protein powder, 20% of wheat flour and 10% of allicin.

The slow-release adhesive comprised the following ingredients in percentage by mass: 65% of sodium alginate, 20% of hydroxypropyl methylcellulose and 15% of sodium polyacrylate.

Referring to the schematic diagram of the preparation process shown in FIG. 1, the aquarium paster feed with the slow-release function in this example was prepared by the following preparation method, which comprised the following steps of:
(1) Preparation of raw materials: amount of each raw material was calculated according to a weight of a paster required, raw materials of the granulated feed A and the granulated feed B were accurately weighed, pulverized and mixed, then expanded and granulated, and then dried at a temperature of above 70° C. for more than 15 minutes until moisture in the granulated feed A and the granulated feed B was below 10%, drying was stopped and the granulated feed A and the granulated feed B were obtained;
(2) Pre-mixing of raw materials: 20% by mass of the granulated feed A and 4% by mass of the slow-release binding agent were transferred into a mixer for uniform mixing;
(3) Total mixing of raw materials: 76% by mass of the granulated feed B was poured into the mixture of step (2), and stirred and mixed evenly again;
(4) Tablet molding: the mixed raw materials obtained in step (3) were transferred to a tabletting press for tabletting to obtain the aquarium paster feed with the slow-release function in this example; and
(5) Packaging and warehousing: the aquarium paster feed obtained in step (4) was packaged according to a specified packing specification to ensure the product to be matched with an outer box, correctness of a production date and a shelf life, and the product was placed into a finished product warehouse as required.

### Example 3

This example provided an aquarium paster feed with a slow-release function, which comprised the following ingredients in percentage by mass: 25% of granulated feed A, 72% of granulated feed B and 3% of slow-release binding agent. 0.1 mm≤the particle size of the granulated feed A≤0.3 mm; and 0.3 mm<the particle size of the granulated feed B≤1 mm, and the ingredients of the granulated feed A and the granulated feed B were the same.

Both the granulated feed A and the granulated feed B comprised the following ingredients in percentage by mass:

20% of fish protein powder, 30% of Antarctic krill protein powder, 15% of Acetes Chinensis protein powder, 5% of corn flour, 6% of yellow mealworm protein powder, 2% of soybean powder, 15% of beer yeast powder, 2.5% of garlic powder, 1.5% of astaxanthin, 1% of lecithin, 1% of vitamin complex and 1% of trace element complex.

The slow-release adhesive comprised the following ingredients in percentage by mass: 40% of attractant and 60% of slow-release adhesive.

The attractant comprised the following ingredients in percentage by mass: 20% of fish protein powder, 30% of brine shrimp protein powder, 10% of barley worm protein powder, 20% of corn flour and 20% of sodium glutamate.

The slow-release adhesive comprised the following ingredients in percentage by mass: 75% of sodium alginate, 15% of α-starch, 5% of pectin and 5% of polyethylene glycol 400.

Referring to the schematic diagram of the preparation process shown in FIG. 1, the aquarium paster feed with the slow-release function in this example was prepared by the following preparation method, which comprised the following steps of:
(1) Preparation of raw materials: amount of each raw material was calculated according to a weight of a paster required, raw materials of the granulated feed A and the granulated feed B were accurately weighed, pulverized and mixed, then expanded and granulated, and then dried at a temperature of above 70° C. for more than 15 minutes until moisture in the granulated feed A and the granulated feed B was below 10%, drying was stopped and the granulated feed A and the granulated feed B were obtained;
(2) Pre-mixing of raw materials: 25% by mass of the granulated feed A and 3% by mass of the slow-release binding agent were transferred into a mixer for uniform mixing;
(3) Total mixing of raw materials: 72% by mass of the granulated feed B was poured into the mixture of step (2), and stirred and mixed evenly again;
(4) Tablet molding: the mixed raw materials obtained in step (3) were transferred to a tabletting press for tabletting to obtain the aquarium paster feed with the slow-release function in this example; and
(5) Packaging and warehousing: the aquarium paster feed obtained in step (4) was packaged according to a specified packing specification to ensure the product to be matched with an outer box, correctness of a production date and a shelf life, and the product was placed into a finished product warehouse as required.

### Example 4

This example provided an aquarium paster feed with a slow-release function, which comprised the following ingredients in percentage by mass: 30% of granulated feed A, 68% of granulated feed B and 2% of slow-release binding agent. 0.1 mm≤the particle size of the granulated feed A≤0.3 mm; and 0.3 mm<the particle size of the granulated feed B≤1 mm, and the ingredients of the granulated feed A and the granulated feed B were the same.

Both the granulated feed A and the granulated feed B comprised the following ingredients in percentage by mass:
15% of fish protein powder, 30% of wheat flour, 5% of corn flour, 9% of Daphnia, 35% of soybean powder, 2% of beer yeast powder, 2.1% of garlic powder, 0.4% of astaxanthin, 0.5% of lecithin, 0.5% of vitamin complex and 0.5% of trace element complex.

The slow-release binding agent comprised the following ingredients in percentage by mass: 50% of attractant and 50% of slow-release adhesive.

The attractant comprised the following ingredients in percentage by mass: 10% of fish protein powder, 20% of Daphnia protein powder, 30% of Chironomid Larva protein powder, 15% of mugwort leaf powder, 15% of betain and 10% of allicin.

The slow-release adhesive comprised the following ingredients in percentage by mass: 85% of sodium alginate, 5% of α-starch, 5% of sodium carboxymethyl cellulose and 5% of polyethylene glycol 400.

Referring to the schematic diagram of preparation process shown in FIG. 1, the aquarium paster feed with the slow-release function in this example was prepared by the following preparation method, which comprised the following steps of:
(1) Preparation of raw materials: amount of each raw material was calculated according to a weight of a paster required, raw materials of the granulated feed A and the granulated feed B were accurately weighed, pulverized and mixed, then expanded and granulated, and then dried at a temperature of above 70° C. for more than 15 minutes until moisture in the granulated feed A and the granulated feed B was below 10%, drying was stopped and the granulated feed A and the granulated feed B were obtained;
(2) Pre-mixing of raw materials: 30% by mass of the granulated feed A and 2% by mass of the slow-release binding agent were transferred into a mixer for uniform mixing;
(3) Total mixing of raw materials: 68% by mass of the granulated feed B was poured into the mixture of step (2), and stirred and mixed evenly again;
(4) Tablet molding: the mixed raw materials obtained in step (3) were transferred to a tabletting press for tabletting to obtain the aquarium paster feed with the slow-release function in this example; and
(5) Packaging and warehousing: the aquarium paster feed obtained in step (4) was packaged according to a specified packing specification to ensure the product to be matched with an outer box, correctness of a production date and a shelf life, and the product was placed into a finished product warehouse as required.

### Example 5

This example provided an aquarium paster feed with a slow-release function, which comprised the following ingredients in percentage by mass: 35% of granulated feed A, 64% of granulated feed B and 1% of slow-release binding agent. 0.1 mm≤the particle size of the granulated feed A≤0.3 mm; and 0.3 mm<the particle size of the granulated feed B≤1 mm, and the ingredients of the granulated feed A and the granulated feed B were the same.

Both the granulated feed A and the granulated feed B comprised the following ingredients in percentage by mass:
10% of fish protein powder, 11% of wheat flour, 20% of corn flour, 20% of yellow mealworm protein powder, 3% of Daphnia, 10% of soybean powder, 3% of beer yeast powder, 2% of garlic powder, 15% of spirulina powder, 5% of lecithin, 0.5% of vitamin complex and 0.5% of trace element complex.

The slow-release binding agent comprised the following ingredients in percentage by mass: 50% of attractant and 50% of slow-release adhesive.

The attractant comprised the following ingredients in percentage by mass: 15% of fish protein powder, 20% of freshwater shrimp protein powder, 20% of Chironomid Larva protein powder, 20% of yellow mealworm protein powder, 10% of corn flour, 5% of sodium glutamate and 10% of allicin.

The slow-release adhesive comprised the following ingredients in percentage by mass: 85% of sodium alginate, 10% of α-starch and 5% of sodium polyacrylate.

Referring to the schematic diagram of preparation process shown in FIG. 1, the aquarium paster feed with the slow-release function in this example was prepared by the following preparation method, which comprised the following steps of:
(1) Preparation of raw materials: amount of each raw material was calculated according to a weight of a paster required, raw materials of the granulated feed A and the granulated feed B were accurately weighed, pulverized and mixed, then expanded and granulated, and then dried at a temperature of above 70° C. for more than 15 minutes until moisture in the granulated feed A and the granulated feed B was below 10%, drying was stopped and the granulated feed A and the granulated feed B were obtained;
(2) Pre-mixing of raw materials: 35% by mass of the granulated feed A and 1% by mass of the slow-release binding agent were transferred into a mixer for uniform mixing;
(3) Total mixing of raw materials: 64% by mass of the granulated feed B was poured into the mixture of step (2), and stirred and mixed evenly again;
(4) Tablet molding: the mixed raw materials obtained in step (3) were transferred to a tabletting press for tabletting to obtain the aquarium paster feed with the slow-release function in this example; and
(5) Packaging and warehousing: the aquarium paster feed obtained in step (4) was packaged according to a specified packing specification to ensure the product to be matched with an outer box, correctness of a production date and a shelf life, and the product was placed into a finished product warehouse as required.

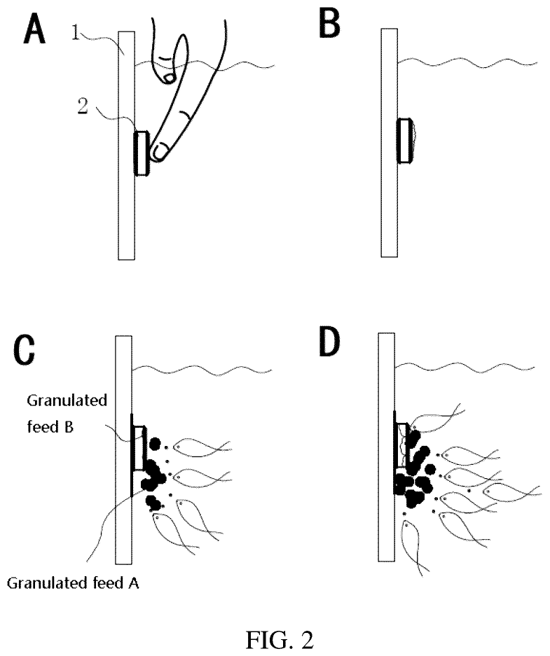

When the aquarium paster feeds in examples 1-5 of the present disclosure were used, the aquarium paster feeds could be attached to an inner wall of an aquarium feeding container by pressing (as shown in FIG. 2A, wherein 1 referred to the aquarium feeding container and 2 referred to the aquarium paster feed), the aquarium paster feeds begun to absorb water and expand (as shown in FIG. 2B), and the aquarium paster feeds begun to slowly release the granulated feed A and the granulated feed B through the bite of fish (as shown in FIG. 2C). Then more fish were attracted to eat the granulated feed A and the granulated feed B (as shown in FIG. 2D).

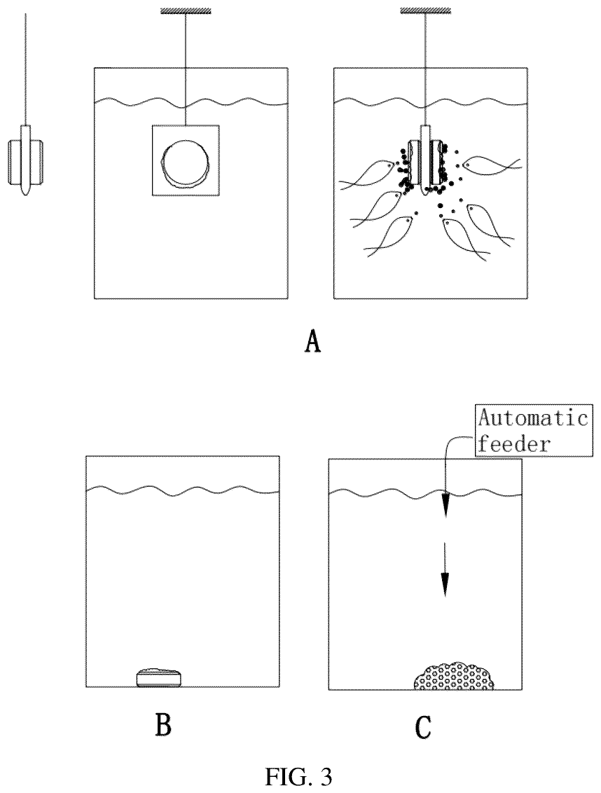

When the aquarium paster feeds in examples 1-5 of the present disclosure were used, the aquarium paster feeds could also be attached to a hanging feed placing unit (as shown in FIG. 3A), so that the aquarium paster feeds could be hung in the aquarium feeding container, and a hanging height could be adjusted when it is used, so that aquarium creatures living in different depths could eat the feeds, thereby reducing the difference of body growth between the aquarium creatures.

When the aquarium paster feeds in examples 1-5 of the present disclosure were used, the aquarium paster feeds could be directly placed at the bottom of the aquarium container (as shown in FIG. 3B). As the granulated feed A and the granulated feed B were bonded together by the slow-release adhesive, the granulated feed A and the granulated feed B were slowly released during use. However, when a conventional loose granulated aquarium feed was fed into the aquarium feeding container by manual or automatic feeder, if the aquarium creatures could not eat the feed in time, the feed would automatically sink to the bottom of the aquarium feeding container (as shown in FIG. 3C), which would cause feed spoilage over time, and produce bad smell or a large number of microorganisms, thus affecting the health of aquarium creatures and even causing the death of aquarium creatures.

### Comparative Example 1

This example provided an ordinary aquarium feed (commercially available feed), which comprised the following ingredients in percentage by mass: 18% of fish protein powder, 23% of wheat flour, 10% of soybean powder, 4% of starch, 5% of corn flour, 6% of beer yeast powder, 8% of wheat germ, 10% of yellow mealworm protein powder, 1% of fish oil, 5% of spirulina powder, 5% of rice bran, 1% of garlic, 1.5% of vitamin complex, 1.3% of trace element complex and 1.2% of others.

The ordinary aquarium feed in this example was obtained by steps of: all the raw materials were pulverized and mixed, expanded and granulated, and then dried at a temperature of above 70° C. for more than 15 minutes until moisture in the feed was below 10%, then drying was stopped.

### Performance Test:

In order to evaluate influences of the ordinary feed and the aquarium paster feed with slow-release function on water quality, food intake and aquarium creatures growth, a series of experiments were designed, and specific experimental methods were as follows.

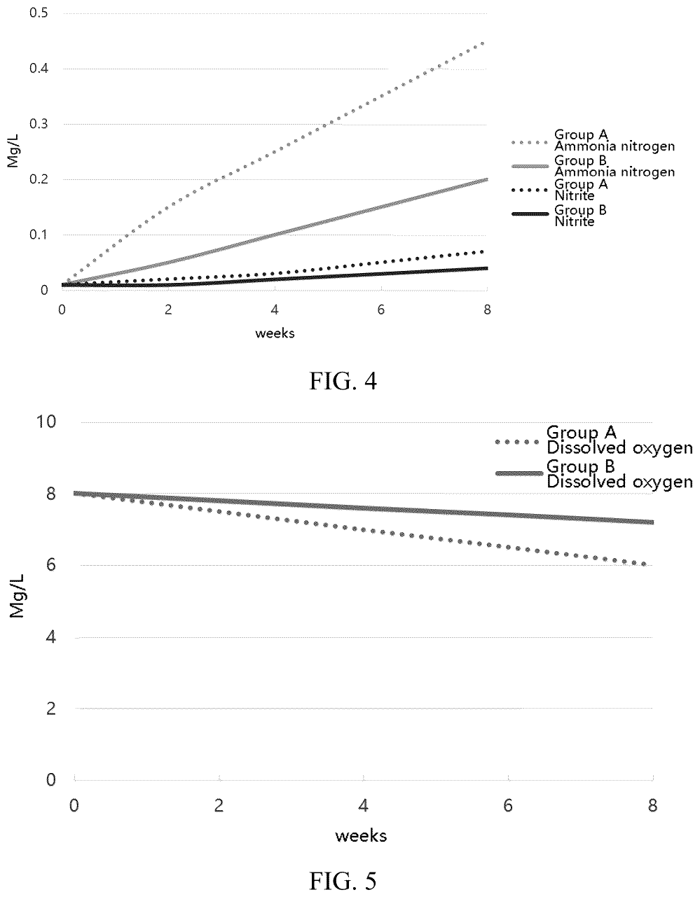

60 healthy goldfish (Carassius auratus) with similar body color and body weight (average weight of 10.2 g) were randomly divided into 2 groups, which were recorded as group A and group B. The group A was fed with the commercially available feed in Comparative Example 1, while the group B was fed with the aquarium paster feed with the slow-release function in example 1, with 3 replicates for each group, and 10 goldfish for each replicate. The independent and effective aquaculture water was 100 L. During the experiment, the goldfish were fed 3 times a day (feeding time: at 8:00 am, 13:00 pm and 18:00 pm), a daily feeding amount was 3% of the body weight of the goldfish, and the experimental period was 8 weeks. During the experiment, a water sample was taken every 2 weeks to determine the concentrations of ammonia nitrogen (NH₃—N), nitrite (NO₂) and dissolved oxygen (DO) in the aquaculture water, and the amount of daily food intake of the goldfish was recorded. At the beginning and end of the experiment, weight data of each goldfish in each experimental group was collected, and the data of food intake rate, weight growth rate, feed conversion rate (FCR) and difference of fish body length within group (in the group A or the group B) of the goldfish were calculated. The detailed test results were shown in FIGS. 4-7 and Table 1, respectively.

Calculation formulas of food intake rate, weight growth rate, feed conversion rate (FCR) and difference of fish body length were as follows:

$$Food intake rate = amount of total food intake / [ experimental days \times ( initial weight + final weight ) / 2 ] \times 100 \%$$

$$Weight growth rate = ( final weight - initial weight ) / initial weight \times 100 \%$$

$$Feed conversion rate = amount of total food intake / ( final weight - initial weight )$$

$$Difference of body length = ( final body length - final average body length ) / final average body length \times 100 \%$$

According to FIG. 4 and FIG. 5, the group A was fed with the commercially available feed in Comparative Example 1, the concentrations of ammonia nitrogen and nitrite in the water were gradually increased over time, and the concentration of dissolved oxygen was gradually decreased. The group B was fed with the aquarium paster feed in Example 1 of the present disclosure, the water quality index of the water was changed smoothly, the concentrations of ammonia nitrogen and nitrite were significantly lower than those of the group A fed with the ordinary feed, and the concentration of dissolved oxygen was higher than that of the group A fed with the ordinary feed, which indicated that the aquarium paster feed of the present disclosure had less pollution to water quality compared with the commercially available ordinary feed.

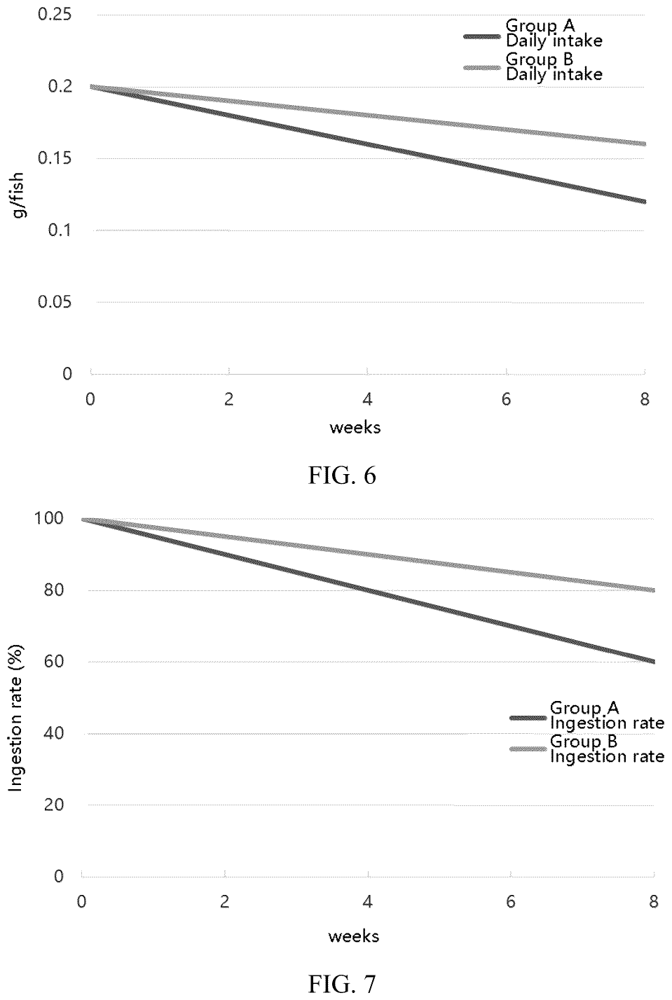

According to FIG. 6 and FIG. 7, the group A was fed with the commercially available feed in Comparative Example 1, the food intake rate of the group A was decreased over time, and the amount of daily food intake was gradually decreased. The group B was fed with the aquarium paster feed in Example 1, and the food intake rate and the amount of daily food intake of the group B were relatively high and stable, which indicated that the aquarium paster feed in the present disclosure could better keep the fish's interest in eating, so that the fish could keep high food intake rate and amount of daily food intake.

TABLE 1
Test data of weight growth rate, feed conversion
rate and difference of body length within group

| | Ordinary feed in | Paster feed in |
|---|---|---|
| | Comparative Example 1 | Example 1 |
| Group | (group A) | (group B) |
| Weight growth rate (%) | 39.45 ± 0.24 | 60.03 ± 0.33 |
| Feed conversion rate | 1.85 ± 0.52 | 1.33 ± 0.46 |
| (FCR) | | |
| difference of Body length | 22.14 ± 0.45 | 15.21 ± 0.65 |
| within group (%) | | |

According to Table 1, the weight growth rate of the group A fed with the commercially available feed in Comparative Example 1 was low, the feed conversion rate was high, and the difference of body length within group was large. However, the weight growth rate of the group B fed with the aquarium paster feed in Example 1 of the present disclosure was significantly higher than that of the group A fed with the ordinary feed, the feed conversion rate of the group B was low, and the difference of body length within group was relatively low, which indicated that the aquarium paster feed in the present disclosure was helpful to balance the body size of fish in the population, so as to reduce the competitive pressure of large fish to small fish, and the weight growth rate was significantly increased.

According to FIG. 4 to FIG. 7 and Table 1, compared with the commercially available feed in Comparative Example 1, the aquarium paster feed with the slow-release function in the present disclosure had better effects in improving water quality, maintaining fish's interest in eating, promoting the growth and reducing the difference of body length within group, and by slowly releasing nutrients, not only the utilization efficiency of the feed was improved, but also the water pollution was effectively reduced. At the same time, it can provide a more balanced nutritional supply for fish of different sizes, reduce the devouring rate between fish, and promote healthy growth of the overall fish population.

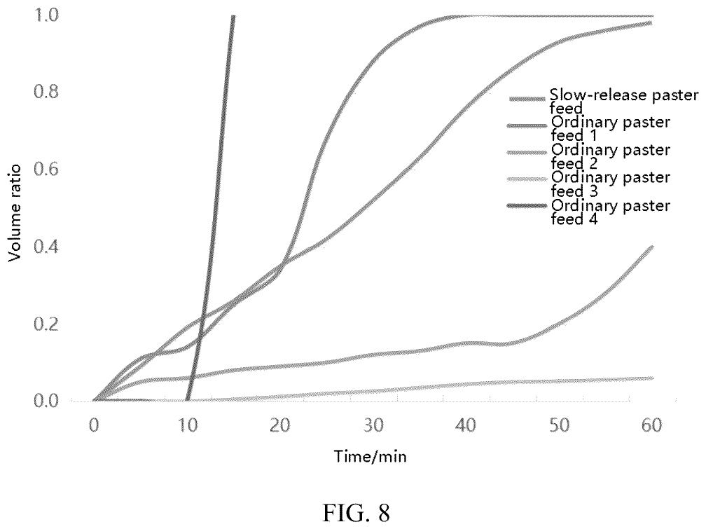

In order to visually observe the slow-release effect of the aquarium paster feed with the slow-release function in Example 1, the following experiments were designed: 5 semi-cylindrical transparent measuring cylinders with a diameter of 20 mm and a volume of 100 mL were prepared, and filled with the same amount of normal-temperature tap water. Meanwhile, the aquarium paster feed with the slow-release function in Example 1 (recorded as slow-release paster feed) and 4 kinds of commercially available ordinary paster feeds (recorded as ordinary paster feed 1, ordinary paster feed 2, ordinary paster feed 3 and ordinary paster feed 4) were stuck on the same position under the water, and continuously pressed for 5 seconds to stick on a cylindrical surface. A volume slowly released from each paster feed was observed and recorded every 5 minutes, and was continuously recorded for 60 minutes. Detailed test results were as shown in FIG. 8. According to FIG. 8, the aquarium paster feed with the slow-release function in Example 1 of the present disclosure had the most even slow-release speed in water, and the feed particles could be released at a relatively stable speed during the experiment. However, the disintegration speed of the commercially available ordinary paster feed 1 in middle and later stages of the experiment was significantly increased; the hardness of the ordinary paster feed 2 and the ordinary paster feed 3 were both high, and it is not easy for the internal structures of the feeds to absorb water and expand, so that the slow-release speeds of those feeds were too low. The viscosity of the ordinary paster feed 4 was low after entering the water, and the feed was detached from the cylindrical surface after about 15 minutes, which did not meet the basic requirements for the use of paster feed.

To sum up, the aquarium paster feed with the slow-release function in the present disclosure could be slowly released into tiny particles with uneven particle size in water, allowing fish with different body sizes or fish in different water layers (comprising surface, middle and bottom layers) to find suitable food for themselves. It not only avoids the waste of feed, but also provides convenience for feeders, without the need to purchase different specifications of feeds for fish with different body sizes. Moreover, the slowly released feed particles slowly sink in the water, which conforms to the original ecological food state and increases the palatability of fish.

The aquarium paster feed with the slow-release function in the present disclosure has less burden on the stomach after being eaten by fish, and can be better decomposed and absorbed by the digestive system of fish, which improves the nutrient conversion rate of the feed, and is helpful to improve the growth rate and health state of fish. Moreover, the aquarium paster feed in the present disclosure can work stably under different water quality and water temperature conditions, and is suitable for various aquarium environments, including fresh water and seawater fish tanks. In addition, the particles slowly released from the aquarium paster feed with the slow-release function in the present disclosure in water are helpful to stimulate the fish to eat actively, and this positive food intake behavior can improve the activity and physical fitness of fish, thus being helpful to maintain good physique and vitality of the fish.

The slow-release adhesive used in the aquarium paster feed with the slow-release function in the present disclosure comprises, but is not limited to, α-starch, pectin, hydroxypropyl methylcellulose, and the like, suitable natural slow-release adhesive ingredients can be used according to use requirements, and the use of synthetic chemical slow-release adhesive is avoided, thus reducing potential safety risks.

The preparation method of the aquarium paster feed in the present disclosure uses a direct tabletting process after mixing the granulated feeds with different particle sizes and the slow-release binding agent, which skips the drying process, avoids contact with moisture, reduces the risk of subjecting to microbial contamination, and helps to protect the stability of moisture or heat sensitive raw materials, prevents degradation or deterioration, and significantly reduces the production process, reduces production cost, and improved production efficiency.

The embodiments of the present disclosure have been described in detail above, but the present disclosure is not limited to the above embodiments. Various changes can also be made within the knowledge scope of those of ordinary skill in the art without departing from the purpose of the present disclosure. In addition, the embodiments and features in the embodiments of the present disclosure can be combined with each other without conflict.

1. An aquarium feed, wherein raw materials of the aquarium feed comprise granulated feeds with different particle sizes and a slow-release binding agent; the granulated feeds with different particle sizes are bonded by the slow-release binding agent; the slow-release binding agent comprises an attractant and a slow-release adhesive; and the slow-release adhesive is gel-like in water.

2. The aquarium feed according to claim 1, wherein the aquarium feed comprises the following raw material ingredients in percentage by mass: 15-35% of granulated feed A, 64-80% of granulated feed B and 1-9% of slow-release binding agent; and a particle size of the granulated feed A is smaller than that of the granulated feed B.

3. The aquarium feed according to claim 2, wherein 0.1 mm≤the particle size of the granulated feed A≤0.3 mm; and 0.3 mm<the particle size of the granulated feed B≤1 mm.

4. The aquarium feed according to claim 1, wherein a mass ratio of the attractant to the slow-release adhesive is 1:(0.5-10);
wherein the slow-release adhesive is selected from the group consisting of sodium alginate, α-starch, pectin, hydroxypropyl methylcellulose, sodium carboxymethyl cellulose, polyethylene glycol 400 and sodium polyacrylate.

5. The aquarium feed according to claim 1, wherein the attractant is selected from the group consisting of animal based attractant, plant based attractant and synthetic attractant.

6. The aquarium feed according to claim 5, wherein the animal based attractant is selected from the group consisting of aquatic animal protein powder and insect protein powder;
wherein the plant based attractant is selected from the group consisting of corn flour, wheat flour and mugwort leaf powder; and
wherein the synthetic attractant is selected from the group consisting of betain, allicin and sodium glutamate.

7. The aquarium feed according to claim 1, wherein the aquarium feed is a paster feed.

8. The aquarium feed according to claim 2, wherein the granulated feed A comprises the following raw materials in percentage by mass: 10-55% of fish protein powder, 0-45% of shrimp, 0-30% of wheat flour, 0-20% of corn flour, 0-20% of yellow mealworm protein powder, 0-9% of Daphnia, 2-35% of soybean powder, 2-15% of beer yeast powder, 1.5-2.5% of garlic powder, 0.4-15% of pigment, 0.5-5% of lecithin, 0.5-1% of vitamin complex and 0.5-1% of trace element complex.

9. The aquarium feed according to claim 2, wherein the granulated feed B comprises the following raw materials in percentage by mass: 10-55% of fish protein powder, 0-45% of shrimp, 0-30% of wheat flour, 0-20% of corn flour, 0-20% of yellow mealworm protein powder, 0-9% of Daphnia, 2-35% of soybean powder, 2-15% of beer yeast powder, 1.5-2.5% of garlic powder, 0.4-15% of pigment, 0.5-5% of lecithin, 0.5-1% of vitamin complex and 0.5-1% of trace element complex.

10. A preparation method of the aquarium feed, comprising the following steps of:
mixing a granulated feed with different particle sizes and a slow-release binding agent to obtain a mixture, and tabletting the mixture to obtain the aquarium feed, the slow-release binding agent comprise an attractant and a slow-release adhesive; and the slow-release adhesive is gel-like in water.

11. The preparation method of the aquarium feed according to claim 10, wherein the granulated feeds with different particle sizes are granulated feed A and granulated feed B, and a particle size of the granulated feed A is smaller than that of the granulated feed B.

12. The preparation method of the aquarium feed according to claim 10, wherein 0.1 mm≤the particle size of the granulated feed A≤0.3 mm; and 0.3 mm<the particle size of the granulated feed B≤1 mm.

13. The preparation method of the aquarium feed according to claim 10, wherein the slow-release adhesive is selected from the group consisting of sodium alginate, α-starch, pectin, hydroxypropyl methylcellulose, sodium carboxymethyl cellulose, polyethylene glycol 400 and sodium polyacrylate.

14. The preparation method of the aquarium feed according to claim 10, wherein the attractant is selected from the group consisting of animal based attractant, plant based attractant and synthetic attractant.

15. The preparation method of the aquarium feed according to claim 14, wherein the animal based attractant is selected from the group consisting of aquatic animal protein powder and insect protein powder;
wherein the plant based attractant is selected from the group consisting of corn flour, wheat flour and mugwort leaf powder; and
wherein the synthetic attractant is selected from the group consisting of betain, allicin and sodium glutamate.

16. The preparation method of the aquarium feed according to claim 11, wherein the granulated feed A or B is prepared by steps of: mixing and pulverizing various raw materials of the granulated feed A or B, and then granulating.

17. A use method of the aquarium feed according to claim 1, comprising the following step of:
pasting the aquarium feed on a fixed object or a movable object.

18. The use method of the aquarium feed according to claim 17, wherein the fixed object comprises an aquarium feeding container.

19. The use method of the aquarium feed according to claim 17, wherein the movable object comprises a movable hanging object.

20. A use method of the aquarium feed according to claim 7, comprising the following step of: pasting the aquarium paster feed on an inner wall of the aquarium feeding container; and/or, pasting the aquarium paster feed on the movable hanging object.
